(19) United States
(12) Patent Application Publication
(10) Pub. No.: US 2023/0389569 A1
(43) Pub. Date: Dec. 7, 2023

(54) GELLING COMPOSITION FOR PLANT-BASED FOOD PRODUCT

(71) Applicant: DUPONT NUTRITION BIOSCIENCES APS, Kongens Lyngby (DK)

(72) Inventors: Helge Henrik Nielsen, Helsinge (DK); Sofie Laage Christiansen, Risskov (DK); Christian Klein Larsen, Leirsund (NO); Dorthe Stenbaek, Risskov (DK)

(21) Appl. No.: 18/248,450

(22) PCT Filed: Oct. 8, 2021
(86) PCT No.: PCT/EP2021/077907

§ 371 Date: Apr. 10, 2023

Related U.S. Application Data
(60) Provisional application No. 63/089,592, filed on Oct. 9, 2020.

(30) Foreign Application Priority Data
Oct. 9, 2020 (EP) 20201082.3
Jun. 18, 2021 (EP) 21180314.3

(51) Int. Cl. A23J 3/16; A23J 3/22; A23L 29/256; A23L 33/185

(52) U.S. Cl. CPC A23J 3/16; A23J 3/227; A23L 29/256; A23L 33/185

(57) ABSTRACT

The present invention relates to a gelling composition to produce a plant-based food product. The composition comprises a mixture of plant-based protein, salts of alginate and a calcium source. In addition, the invention also relates to the plant-based food product containing the composition and the process of producing the same.

### FIELD OF THE INVENTION

The present invention relates to a gelling composition to produce a plant-based food product. The composition comprises a combination of ingredients to produce a gel with desirable texture to the food product at uncooked, hot or cold conditions for optimal bite and juiciness. In addition, the invention also relates to the plant-based food product containing the composition and the process of producing the same.

### BACKGROUND OF THE INVENTION

Plant-based meat substitute food products have enjoyed exceptional popularity in recent years due to the trends of increased vegetarianism and veganism. These trends are supported by scientific data reporting and suggesting that by moving to a predominantly plant-based diet individuals can make a significant contribution to mitigating the negative effects of climate change (Springmann, M.; Charles, H.; Godfray, J.; Raynor, M.; & Scarborough, P.; 2016, PNAS “Analysis and Valuation of Health and Climate Change Co-benefits of Dietary Change”, doi.org10.1073/pnas.1523119113). These authors move on to conclude that significant climatic benefits purport from humans consuming on average 15% less calories whilst increasing fruit and vegetable consumption by 25% with a concomitant reduction of meat by 56%. In a further paper Springmann et al (2018) report that changing to a more plant-based diet could result in significant reductions in climatic greenhouse gases (Marco Springmann at al, “Options for keeping the food industry within environmental limits.” (2018), Nature, 562, 519-525).

Important for meat alternative products is the need for such products to be perceived as good as the equivalent meat products both taste and texture wise by the consumer. This means that the vegetable-based alternatives to meat products like burgers, patties, bacon, whole muscle products (e.g. steaks, schnitzels), bratwurst and hotdogs (frankfurters, wieners) must be perceived as having an acceptable equivalent visual appearance, mouthfeel, taste and texture.

The texture of cooked meat products is the result of both the meat pieces in the product as well as salt- and phosphate-soluble meat proteins, which during cooking are coagulating/gelling like egg-white in an omelet, thereby homogeneously adhering to and immobilizing the meat pieces in the product. In meat products with a low(er) meat content the texture created by the gelled soluble meat proteins are often further amplified by the addition of hydrocolloids like for example carrageenan and starches.

Plant proteins also have the capability of gelling by heating like salt- and phosphate-soluble meat proteins. However, some plant protein that gels based on abundantly available vegetable proteins, like soy or pea isolates, which have already been heat denatured in the protein production process, are not so strong as the meat protein gels. In vegetarian meat alternative products egg-white is therefore often used to strengthen the gel, but that is not an option in vegan meat alternative products. Methyl cellulose is a preferred hydrocolloid in vegan meat alternative products, as it provides the desired texture in hot consumed products. However, when cooled down the methyl cellulose gel will melt, i.e. vegan meat alternative products would often also need to contain vegan acceptable ingredients providing the desired texture in the cold vegan meat alternative product, like for example carrageenan.

Additionally, there is also a trend within the meat alternative solutions, to avoid the use of methyl cellulose (MC) (E461) as food additive, because of the pressure for having clean or cleaner label food products avoiding ingredients having “chemical” names unfamiliar to many consumers. The present solutions are related to a composition which is free of MC and still provides the desired gelling properties and textures for the desired application in meat alternative products.

US2003211228A relates to a process of making a meat or meat alternative product by using animal protein or vegetable proteins in combinations with alginate, calcium sulphate, phosphate and calcium chloride, the purpose being to make a fibrous product with meat like texture. However, that process generates a product with fibrous structure, not a homogeneous strong vegetable protein/emulsion gel, which could then be minced (like minced meat) and turned into a minced vegan product resembling the texture of minced meat.

Likewise, the US2010/136202A1 (see for example the paragraphs [0010]-[0021], [0043]-[0053], [0114]-[0115] and [0054]) describes the production of a non-homogeneous fibrous product through the reaction of alginates with di- and tri-valent cat-ions. The described procedure is causing the alginate to gel instantly thereby producing the fibrous texture, which could be referred to as a broken gel or gel filaments, whereas the procedure taught in the present invention very much focuses on the production of homogeneous gels, which can constitute the final foodstuff providing both the required hot and cold texture of the food product. A delayed release of the di- or more valent ions is desired in order to prepare a homogeneous gel structure, which is not possible by the process taught in US2010/136202A1.

Likewise, the EP1790233A1 (see examples 2 and 3) describes the production of a non-homogeneous fibrous product by using alginate and calcium chloride, which causes the alginate to gel instantly thereby producing a non-homogeneous fibrous product, which is filtered off from the free liquid.

EP1493337A2 relates to a process for preparing a vegan burger applying methyl cellulose. However, there is no prior art describing a vegan burger without methyl cellulose using the alginate gelling techniques taught in the present invention.

Alternative ingredients to methyl cellulose, which would also provide heat stable gels, would include alginates, LA-gellan gum, LM pectin and curdlan gum. However, only alginate salts (alginates) are cold soluble and thereby fits well with the processes traditionally used to produce meat products and meat alternative products.

Alginates will gel instantly in the presence of di-valent cat-ions like calcium ions at temperatures below 70° C. However, alginate gels would not reform when broken, in contrast to iota-carrageenan gels, which are used commercially for example in the production of cold filled gelled dairy desserts. Therefore, it is important to control the presence of calcium ions in the process, so that a desired homogeneous gel would not be broken during the process. This is typically done using slow-release calcium salts also known as sparingly soluble calcium salts like calcium sulphate, di-calciumphosphate, calcium citrate and calcium carbonate, and a sequestrant like tetrasodiumpolyphosphate (TSPP), Sodium-hexametaphosphate (SHMP) and trisodium citrate. Sequestrants are complexing agents that have a high affinity for di- and tri-valent ions like the ones mentioned above (without limitation). Combinations of an alginate salt, a sparingly soluble calcium salt and a sequestrant is called a self-gelling alginate system. When added to water, the ingredients will start to dissolve, but as the sequestrant has a higher affinity for calcium ions than the alginate, the calcium ions released from the sparingly soluble calcium salt will be captured by the sequestrant leaving the alginate in its soluble form. This will continue until the sequestrant has been saturated, where after the released calcium ions from the sparingly soluble calcium salt will be captured by alginate causing it to gel. The time it takes for the sequestrant to be saturated is the available processing time for mixing operations. When the alginate starts to gel, the product must be left untouched until the gelling is completed. This can take several hours.

The meat industry is using considerable amounts of mechanically deboned poultry meat (MDM), which is produced from squeezing poultry carcasses. The MDM has a paste structure, i.e. no muscle meat structure at all. Self-gelling alginates, e.g. sodium alginate plus calcium sulphate plus TSPP can be used to turn the MDM paste structure into a strong MDM gel, which can then be minced or chopped into the desired size of pieces. These gelled MDM pieces can then be used in sausages instead of more expensive pieces of lean meat to produce the desired texture and bite in a more affordable finished product. The gelled MDM pieces are mixed with a “binding dough” consisting of a lean meat fraction containing salts and phosphate, which would then extract the salt- and phosphate-soluble proteins from the finely chopped lean meat. During cooking this binding dough would gel, thereby adhering to and immobilizing the gelled MDM pieces in a homogeneous meat gel constituting the finished cooked meat product. The gelled MDM can be produced by mixing for example 64% MDM with 32% water/ice (50/50) and 4% of a self-gelling alginate (sodium alginate, calcium sulphate, TSPP) in a bowl chopper for around 5 minutes, followed by leaving the mixture overnight in the fridge for gelling.

Despite the mentioned solutions related to meat-based products, its direct application into plant-based food products is not obvious, since the gelling of vegetable proteins with alginate does not seem to be so straight forward as for other proteins. Some of these difficulties are explained in the article “The effects of sodium alginate and calcium levels on pea proteins cold-set gelation, Jean-LucMessiona, Coralie Blancharda, Fatma-VallMint-Daha, Céline Lafargea, Ali Assifaouiab, Remi Saurela, Food Hydrocolloids, Volume 31, Issue 2, June 2013, Pages 446-457”.

Reference in this regard is also made to the article “Impact of phase separation of soy protein isolate/sodium alginate co-blending mixtures on gelation dynamics and gels properties. Hongyang Panab, Xueming Xub, Yaoqi Tiana, Aiquan Jiaoa, Bo Jianga, Jie Chena, Zhengyu Jinab. Carbohydrate Polymers, Volume 125, 10 Jul. 2015, Pages 169-179 (https://www.sciencedirect.com/science/article/pii/SO144861715001447)”.

The applicant's studies on this subject, started by making a gel with 2% of the DuPont commercial product PROTANAL ME 0434 (Na-alginate, CaSO₄, TSPP) plus 45% sunflower oil plus 51% water, which gave a stronger/firmer gel than if 3% of the DuPont commercial product SUPRO XT 221D (Soy isolate) was also added to the formulation reducing the water content with the same amount. The gel without the SUPRO XT 221D had a Texture Analyzer (TA) (20 mm measuring distance, half inch probe) gel strength breaking point of 366.1 g at 13.1 mm distance, whereas the gel including the 3% SUPRO XT 221D had no breaking point, just a reading of 99.9 g at the 20 mm distance (the maximum penetration according to the test procedure). Thus, the gel with SUPRO XT 221D gives a paste-like texture on the TA graph.

In the present invention, it was therefore, based on our previous experience, surprising that strong gels, which can be minced without becoming a paste, can be made with alginate, soy isolates and/or textured vegetable protein without the presence of certain types of animal derived proteins like for example albumen (egg white), as taught by this invention.

GB2034573A describes in example 2 similarly a homogeneously gelled oil emulsion consisting of 40% oil, 0.82% sodium alginate, 2% soy isolate, 2% albumen (egg white), 0.29% flavorant, 0.53% calcium sulphate and 54.4% water. Interestingly, GB2034573A applies albumen, which will greatly contribute to the gel strength and cannot therefore be compared to the applicant's study described above. GB2034573A is silent about the exact procedure referring to gelled oil emulsions as being well-known technology. However, industrial scale production would also require a sequestrant, typically tetrasodium pyrophosphate, in order to be able to delay the onset of the alginate gelling until the mixing procedure has been finalized.

Several solutions presented in the state of the art for meat alternative solutions includes sparingly soluble calcium salts and the sequestrants used in the typical self-gelling alginate systems are not accepted from a regulatory point of view in certain regions in vegan or vegetarian meat alternative products.

EP0345886A2 describes the use of encapsulated calcium salts as a way to delay the release of the calcium ions in an alginate system for raw meat binding, where small pieces of meat are being “glued” together in a cold-setting process during several hours. The gelling mechanism in raw meat binding is thought to involve calcium bridging between amino acids on the surface of the meat pieces as well as to the alginate, because if it was just a water gel, the gel would slide off of the meat pieces not binding them into a homogeneous product. If the meat pieces are pre-salted in such a system, there would be no binding of the meat pieces at all, as the higher ionic strength apparently disturbs the calcium bridging of the alginate and the meat pieces.

DESMOND E.M. ET AL: “Comparative studies of nonmeat adjuncts used in the manufacture of low-fat beef burgers” Journal of Muscle Foods, vol. 9, no. 3, (1 Aug. 1998), pages 221-241, XP055779925, US. ISSN: 1046-0756, DOI: 10.1111/j. 1745-4573.1998. tb00657.x) describes the use of sodium alginate and calcium lactate for the improvements of cook yield and texture of beef burgers. However, DESMOND E.M. et Al are silent about the procedure, as the Kelco product used in the test is most likely to have been a sodium alginate and an encapsulated calcium lactate. Calcium lactate is a readily soluble calcium salt normally giving rise to alginate spot gelation (gel in fibers) as discussed in EP0345886A2, being the reason for needing an encapsulated calcium lactate, but this is not mentioned by DESMOND et al.

The problem underlying the present invention is to provide a solution which improves the quality of plant-based products in terms of texture and organoleptic properties in connection with a more label-friendly ingredient list, and the use of encapsulated calcium salts and alginates for making plant protein gels both with protein isolates and to bind firmly hydrated textured plant proteins into a homogeneous meat alternative product as described in this invention is surprising and has not previously been taught, and this furthermore opens up for new possibilities for the production of whole muscle-type meat alternative products like steaks and schnitzels.

### OBJECT OF THE INVENTION

The object of the present invention is to provide a gelling composition for producing an improved plant-based food product. The unique combination of the ingredients provides a way to produce a legally accepted, label friendly vegan meat alternative product without the need for methyl cellulose.

### BRIEF DESCRIPTION OF THE DRAWINGS

FIG. 1. Gel strength measurement after 24 hrs. at 5° C. of the combined mixture of a self-gelling alginate (sodium alginate+calcium sulphate+TSPP) emulsion and hydrated textured soy protein (Supromax 5010) (sample 1).

FIG. 2. Comparing gel strength measurements between the combined mixture of a self-gelling alginate (sodium alginate+calcium sulphate+TSPP) emulsion and hydrated textured soy protein (Supromax 5010) (sample 1) versus self-gelling alginate (potassium alginate+calcium sulphate+TSPP) emulsion and hydrated textured soy protein (Supromax 5010) (sample 2). Fermented dextrose was added to the self-gelling alginate in both samples. Gel strength measurements were conducted after 24 hrs. at 5° C.

FIG. 3. Gel strength measurement after 24 hrs. at 5° C. of the combined mixture of a self-gelling alginate (sodium alginate+calcium sulphate+TSPP) emulsion and hydrated soy isolate protein (SuproEX 37 HG IP) (sample 3). Fermented dextrose was added to the self-gelling alginate.

FIG. 4. Gel strength measurement after 24 hrs. at 5° C. of the combined mixture of self-gelling alginate (sodium alginate+calcium sulphate+TSPP) emulsion and hydrated pea isolate protein (Trupo 2000) (sample 4).

FIG. 5. Gel strength measurement after 24 hrs. at 5° C. of the combined mixture of a phosphate free gelling alginate (potassium alginate and encapsulated calcium lactate) emulsion and hydrated soy isolate protein (SuproEX 37 HG IP) (sample 5).

FIG. 6. Comparing gel strength measurements when encapsulated calcium lactate was hydrated with alginate (sample 5) and when sprinkled on after the emulsion was formed (sample 6). Gel strength measurements were conducted after 24 hrs. at 5° C.

FIG. 7. Comparing gel strength measurements between the combined mixture of a phosphate free gelling alginate (potassium alginate and encapsulated calcium lactate) emulsion and hydrated soy isolate protein (SuproEX 37 HG IP) (sample 5) versus one comparable preparation without encapsulated calcium lactate (sample 7). Gel strength measurements were conducted after 24 hrs. at 5° C.

FIG. 8. Comparing gel strength measurements between the combined mixture of a phosphate free alginate system (potassium alginate and encapsulated calcium lactate) emulsion and hydrated soy isolate protein (SuproEX 37 HG IP) (sample 5) versus one comparable preparation with 50% less encapsulated calcium lactate (sample 8). Gel strength measurements were conducted after 24 hrs. at 5° C.

FIG. 9. Comparing gel strength measurements between the combined mixture of a phosphate free alginate system (potassium alginate and encapsulated calcium lactate) emulsion and hydrated soy isolate protein (SuproEX 37 HG IP) (sample 5) versus one comparable preparation without the alginate (sample 9). Gel strength measurements were conducted after 24 hrs. at 5° C.

FIG. 10. Comparing gel strength measurements between the combined mixture of a phosphate free alginate system (potassium alginate and encapsulated calcium lactate) emulsion and hydrated soy isolate protein (SuproEX 37 HG IP) (sample 5) versus one comparable preparation without the protein (SuproEX 37 HG IP) (sample 10). Gel strength measurements were conducted after 24 hrs. at 5° C.

FIG. 11. Comparing gel strength measurements between the combined mixture of a phosphate free alginate system (potassium alginate and encapsulated calcium lactate) emulsion and hydrated soy isolate protein (SuproEX 37 HG IP) (sample 5) and one comparable preparation without oil (sample 11). Gel strength measurements were conducted after 24 hrs. at 5° C.

FIG. 12. Comparing gel strength measurements between the combined mixture of self-gelling alginate (sodium alginate+calcium sulphate+TSPP) emulsion with fermented dextrose (sample 3) and one comparable preparation without fermented dextrose (sample 12). Gel strength measurements were conducted after 24 hrs. at 5° C.

FIG. 13. Gel strength measurement after 24 hrs. at 5° C. of the combined mixture made by dry mixing all ingredients; potassium alginate+encapsulated calcium lactate+SuproEX 37 HG IP (sample 13).

FIG. 14. Gel strength measurement after 24 hrs. at 5° C. of the combined mixture made by dry mixing all ingredients; potassium alginate+encapsulated calcium lactate+50% more SuproEX 37 HG IP compared to sample 13 (sample 14).

FIG. 15. Comparing gel strength measurements between the combined mixture made by dry mixing all ingredients; potassium alginate+encapsulated calcium lactate+fermented dextrose (sample 14) and one comparable preparation without fermented dextrose (sample

### DETAILED DESCRIPTION OF INVENTION

The present invention is based on studies described herein, which surprisingly demonstrate exceptional good quality of the gel obtained by the gelling composition described to produce a plant-based food product. The gelling composition comprising:
a. Plant-based proteins,
b. Alginate salt,
c. Encapsulated Calcium source.

The composition may optionally contain fermented dextrose.

The gelling composition of the invention generates a gel with at least 500 g of gel strength which can be minced without turning it into a paste. Furthermore, the gel can constitute the finished food product, which could be frozen or sliced or diced or cooked followed by cooling and slicing.

Gelling Composition

By gelling composition we mean the combination of ingredients that generate a gel, also claimed in the invention, with the desired technical characteristic to the proposed applications.

Plant-Based Proteins

By plant-based protein we mean protein not stemming from pesco-, ovo-, lacto- or traditional animal meat-based sources. Plant-based proteins tend to have lower values of the essential amino acids such as leucine, isoleucine and valine, and consequently fail to trigger or promote muscle protein synthesis to the same degree. Additionally, antinutritional factors are also predominantly higher when compared with animal-based sources. However, although these components work to reduce ultimate digestibility of proteins, consumption of a balanced variety of plant-based protein does not place negative constraints on dietary efficacy. Indeed, these antinutritional factors can be mitigated by various procedures moving from germination techniques through fermentation and simple soaking of the plant material within standard culinary practice.

The plant-based proteins considered for the invention are selected from isolated soy, texturized soy protein, pea protein, wheat, canola, potato, rapeseed, mungbean, lupin, sunflower, rice, chickpea, oat, cassava, buckwheat, corn, spelt, linseed, arrowroot, sorghum, lentils, favabeans, nava beans, peanuts and almond, or combinations thereof.

Soy Proteins

Soy protein is produced from dehulled and defatted soybean meal, which is processed into three kinds of high protein commercial products: soy flour, concentrates, and isolates. Grinding soybeans to a fine powder results in soy flour, where three categories are prevalent: whole or full-fat, which contains natural oils; defatted, where the oil is removed and the protein content is 20-50%, and either high or low water solubility versions are available; and a lecithinated version is also standard, i.e. where lecithin is added to the soy. Soy protein concentrate (SPC) has a higher soy content, typically around 70%, and in broad general terms is simply defatted soy flour minus the water-soluble carbohydrates. Retaining much of the fiber of the original soybean and SPC examples are routinely used baked goods, breakfast cereals and significantly here, also in meat—and meat alternative products, where its function is to increase water and fat retention as well as enhance nutritional values. Isolated soy protein (ISP) has the highest degree of ‘soy’ purity of all the soy products and holds a minimum soy content of 90%. Also produced from the soy flour it additionally has all the non-protein components removed, and this credits it with a neutral flavour characteristic. SPI products can be used to improve the texture of meat, and meat analogue products as well as increasing the protein content and fortification of the application, whilst retaining moisture and possessing emulsifying properties. All soy types are widely used as functional or nutritional ingredients in a wide variety of food products. Here, soy protein concentrate, and isolated soy protein are the most common advocates for this invention's purpose, albeit the preferred version here is isolated soy protein. Furthermore, textured soy proteins produced in an extrusion process to provide chunks of different sizes are applied for the purpose of this invention.

In terms of protein quality, soy protein is one of the few plant-based proteins which has a Protein Digestibility Corrected Amino Acid Score (PDCAAS) at parity with traditional meat sources.

Pea Proteins

Equivalently, pea protein concentrates and isolates can be produced in manufacturing processes comprising protein extraction, purification, and drying unit operations.

Peas typically contain between 23 and 31% protein and thereafter 1-2% fat together with vitamins, polyphenols and minerals. The proteins themselves fall within the globulin, albumin, prolamin or glutelin types, of which albumins and globulins account for 10-20% and 70-80% respectively. The water-soluble albumin types are thought of as metabolic and enzymatic whereas the globulins are saline soluble and function as storage proteins for seeds. Beyond the protein, peas contain carbohydrates as a mixture of oligo, mono, di- and polysaccharides (up to 60-65%), where the main fraction is starch. Dietary fibre in the form of cellulose, hemicellulose, muciliage and resistant starches are also present at a level in the dried state of between 15-30%. Pea's fat content ranges from 1-2%, with about a quarter of that being made up of oleic acid, and half, linoleic acid. Minerals such as phosphorus, magnesium, calcium, iron, zinc, and copper are likewise present in diminishing order; as well as folic acid, riboflavin, niacin.

In a preferred embodiment of the invention the plant-based proteins are isolated or textured soy proteins or pea proteins.

In the present invention, the textured soy based vegetable Plant-based proteins most preferably used are based on the commercial products Supromax 5010 (size of chunk:length and width is 1-1.5 cm) and Supromax 5050 (size of chunk:length is 4-6 cm and width is 2-3 cm), comprising a blend of isolated soy protein, wheat gluten and wheat starch, a major difference between the two being the size of the chunks. The total protein content being min.

71%. Furthermore, Supromax 6550 (size of chunks:length is 3-5 cm and width is 2-3 cm) is a preferred gluten-free textured vegetable Plant-based protein with a soy protein content of 58%.

In the present invention, the pea based textured Plant-based vegetable proteins most preferably used are the commercial products TRUPROTEX 4000 (2-6 mm flakes) and TRUPROTEX 4650 (2-3 cm chunks) having a protein content of about 75%.

In the present invention, the isolated soy-based vegetable Plant-based protein most preferably used is based on the commercial product SuproEX37 HG IP. Total protein content being min 90%.

In the present invention, the isolated pea-based vegetable Plant-based protein most preferably used is based on the commercial product TRUPRO 2000. Total protein content being min 83%.

In the invention, the plant-based proteins are added in an amount of 1.5-25% and preferably 10-21% by weight of the obtained gel.

Alginate Salts

Alginates, derived from, inter alia, brown seaweeds are linear, unbranched bio-polymers consisting of (1-4)-linked β-D-mannuronic acid (M) and α-L-guluronic acid (G) residues. Alginates are not random copolymers but consist of blocks of similar and alternating sequences of residues, for example, MMMM, GGGG, and GMGM.

Also called algin, alginate is an anionic polysaccharide distributed widely in the cell walls of brown algae, where through binding with water it forms a viscous gum. In extracted form it absorbs water quickly; it is capable of absorbing 200-300 times its own weight in water. Alginate can form heat stable gels with di-valent cat-ions, preferably Calcium. Physical properties of alginates depend on the relative proportion of the M and G blocks. Gel formation at neutral pH requires a calcium source to provide calcium ion to interact with G-blocks. The greater the proportion of these G-blocks, the greater the gel strength.

“Alginate” is the term usually used for the salts of alginic acid, but it can also refer to all the derivatives of alginic acid and alginic acid itself; in some publications the term “algin” is used instead of alginate. Alginate is present in the cell walls of brown algae (Phaeophyceae sp.) as the calcium, magnesium and sodium salts of alginic acid. The goal of the extraction process is to obtain dry, powdered, sodium alginate or potassium alginate. The calcium and magnesium salts do not dissolve in water; the sodium and potassium salts do. The rationale behind the extraction of alginate from the seaweed is to convert all the alginate salts to the sodium or potassium salt, dissolve this in water, and remove the seaweed residue by filtration. The alginate must then be recovered from the aqueous solution. The solution is very dilute, and evaporation of the water is not economic. There are two different ways of recovering the alginate.

The first is to add acid, which causes alginic acid to form; this does not dissolve in water and the solid alginic acid is separated from the water. The alginic acid separates as a soft gel and some of the water must be removed from this. After this has been done, alcohol is added to the alginic acid, followed by sodium carbonate or potassium carbonate which converts the alginic acid into sodium or potassium alginate. The sodium or potassium alginate does not dissolve in the mixture of alcohol and water, so it can be separated from the mixture, dried and milled to an appropriate particle size that depends on its application.

The second way of recovering the sodium alginate from the initial extraction solution is to add a calcium salt. This causes calcium alginate to form with a fibrous texture; it does not dissolve in water and can be separated from it. The separated calcium alginate is suspended in water and acid is added to convert it into alginic acid. This fibrous alginic acid is easily separated, placed in a planetary type mixer with alcohol, and sodium or potassium carbonate is gradually added to the paste until all the alginic acid is converted to sodium or potassium alginate. The paste of sodium or potassium alginate is sometimes extruded into pellets that are then dried and milled. Pea protein, stemming typically from yellow and green split peas (Pisum sativum) is a rich source of non-proteinaceous nutrients such carbohydrates, vitamins and minerals and is generally low in fat. The protein content can be influenced by both genetic and environmental actors and is known to contain all essential amino acids required for the human diet. Functionally, it can be used as a thickener, foaming agent, emulsifier or structuring ingredient.

In the present invention, alginate salts are added in an amount of 0,5-5.0%, preferably 1,2-3,0% by weight of the obtained gel.

Calcium Source

A calcium source should be understood as any compound able to deliver calcium ions to the composition in the proper controlled way according to the process.

In this invention, the encapsulated calcium source is selected from the group of calcium alginate, calcium sulphate, calcium acetate, calcium ascorbate, calcium tartrate, calcium chloride, calcium citrate, di-calcium phosphate and calcium lactate.

Calcium sulphate is an inorganic compound with the formula CaSO₄. It is known in the E number series as E516. Solubility for the dihydrate is 0.24 g/100 g at 20° C., and the solubility product is 3.14×10⁻⁵ mol²L⁻². In some comparative examples of the invention it is used as a sparingly soluble calcium salt.

In the art, a sequestrant is used in addition to alginate and calcium when a delay of the Calcium availability is needed, for example to allow the alginate to solubilize before the Calcium is available for gelation. TSPP, functioning as a sequestrant, also called sodium pyrophosphate or tetrasodium phosphate or TSPP, is an inorganic compound with the formula Na₄ P₂O₇. As a salt, it is a white, water-soluble solid. It is composed of the pyrophosphate anion and sodium ions. Tetrasodium pyrophosphate is used as a buffering agent, an emulsifier, a dispersing agent, and a thickening agent, and is often used as a food additive. In the present invention it is used as a sequestrant having a stronger affinity for calcium than alginate. The sequestrant in the present invention is selected from the group of tetrasodium pyrophosphate, sodium-hexametaphosphate and sodium citrate.

In comparative examples of the invention, the calcium source used is a self-gelling alginate (CaSO₄, sequestrant (TSPP)) consisting of 40-70%, more preferably 50-60% of alginate salt, and the content of the sequestrant (TSPP) is 30-60% of the content of the sparingly soluble calcium salt by dry weight of the composition.

In the preferred embodiment of the invention, the calcium source used is encapsulated calcium lactate, such as the commercial product, Textureze MT230, which can also be used as a source for calcium ions. Ingredient statement: Calcium Lactate Pentahydrate, Hydrogenated Vegetable Oil & Monoglycerides with 48-52% Calcium Lactate Pentahydrate and a particle size of 2% Maximum on #14 Mesh Screen (USSS).

Encapsulation Of Calcium Salts

The encapsulated calcium lactate is present in an amount of 1-8%, preferably 2,4-4.5% by weight of the obtained gel. Encapsulated calcium lactate is present from half (w/w) the amount of the alginate to four times the amount of the alginate.

Known techniques for coating a solid particle or powders can be used to prepare encapsulated Ca-salts. For example, Calcium salts formats like Calcium lactate granules can be coated with a hardened lipid material with a melting point of 50-70° C. The lipid material can be comprised by mono- or mono-di- or tri-acyl-glycerols, or a blend of these. Coating can be performed in a fluidized bed equipment in which the calcium lactate granules are lifted (fluidized) by an air stream while continuously spray-coated with a melt of the lipid coating material. The process should be performed under carefully controlled parameters to ensure solidification of the lipid melt immediately upon impact with the granule surfaces. Each granule is typically exposed to the lipid melt spray multiple times during the coating process, rendering a coating layer with a thickness of several micrometers.

The encapsulated Calcium salt can also be made by other similar techniques like spray chilling or other methods that will result in a coated Calcium salt or a Calcium salt/fat matrix that ensures delayed release of Calcium upon addition to water.

Calcium-Saturation of Alginate

The amount of Calcium that is needed to stoichiometrically saturate the alginate in solution can be calculated. In solution, Calcium is a divalent cation, whereas each alginate monomer has one negative charge on the carboxylic group when dissociated and hydrated in water. Hence, one mole of Calcium ions will ionically saturate two moles of alginate monomers. For a particular Calcium salt, for example Calcium lactate pentahydrate, with the molecular formula CaC₆H₁₀O₆·5H₂O and molecular weight 308 g/mol, the amount needed, on a weight basis, to ionically saturate the alginate can be calculated as follows:

$${weight}_{Ca - lactate pentahydrate} = \frac{1}{2} {weight}_{K - alginate} \times \frac{molar {mass}_{( Ca - lactate pentahydrate )}}{molar {mass}_{K - alginate}}$$

where alginate is in the form of Potassium alginate (with molecular weight 233).

For example, for 1 g Potassium alginate, 0,66 g Calcium lactate pentahydrate is needed to ionically saturate the Potassium alginate (½* 1 g * 308 g/mol/233 g/mol=0,66 g). This amount of Calcium lactate pentahydrate will equal 0,086 g Calcium.

Calcium saturation can be given as a percentage where 100% Calcium-saturation of the alginate means that there are enough Calcium ions to stoichiometrically and ionically saturate all the charges on the alginate molecules. In other words, 0,66 g Calcium lactate pentahydrate means 100% Calcium saturation of the alginate molecules. Or, 0,086 g Calcium will saturate 1 g Potassium alginate, on dry basis.

Obviously, a similar calculation can be performed for other calcium salts, and for other salts of di- and tri-valent ions that form gels with alginate. Similarly, similar calculations can be made for other salts of alginate, for example Sodium alginate.

Fermented Dextrose

Fermented dextrose optionally used in the present invention is a traditionally fermented dextrose, which is pasteurized and spray-dried, and then blended with maltodextrin as a carrier. It contains naturally-produced fermentation metabolites (primarily organic acids but also peptides and aromatic compounds), from common starter cultures with a long, safe history of use in food production. Although added to provide taste, mouthfeel enhancement and improving the freshness and fresh-keeping of a wide range of food products, calcium ions in the product would also be a source of calcium in the present invention.

In an optional embodiment of the present invention, the fermented dextrose is added in an amount of 0,8-2%, preferably 1-1,7% in the gelled part by dry weight of the composition.

In another embodiment, the invention covers a dry blend of the inventive gelling composition, wherein the dry blend is a powder mix of the selected ingredients of the composition: isolated plant-based protein, salts of alginate and encapsulated calcium lactate, optionally fermented dextrose.

The invention also relates to a process for producing the claimed gel, using the gelling composition object of the invention, comprising the steps of:
a) hydrating the blend of isolated plant-based protein, salts of alginate and calcium source;
b) adding oil to turn the product obtained from step a) into an alginate emulsion;
c) hydrating the texturized plant-based protein;
d) mixing the hydrated protein from step c) with the alginate emulsion from step b);
e) leaving the mixture of step d) for gelling at refrigeration temperature for minimum 3 hours;
f) the gel obtained in step e) can be additionally minced;
g) The gel obtained in step e) can constitute the finished product, which could be frozen or sliced or diced or cooked followed by cooling and slicing;
h) The mixture obtained in step d) can be cooked to make the finished gelled food product (cold cut).

Additionally, the invention covers a plant-based food product containing the gel composition obtained by the gelling composition above described, in amounts of 10-100% of the plant-based food product.

The plant-based food product could be a burger, sausage, nuggets, dices for pizza toppings or salads, bacon slices, steaks, schnitzels and the like.

Process for obtaining a plant-based food product is also object of the invention. When the food product is for example a sausage the gelling composition previously described is added and mixed into the final food product mixture prior to forming the finished uncooked food product.

In another embodiment of this invention, the process for obtaining a plant-based food product wherein the final product is a plant-based bacon, comprises the steps of placing different layers of the obtained gels with isolated plant-based protein and texturized plant based proteins, prior to gelation to form the final food product.

An alternative process for obtaining a plant-based food product comprises the steps of combining the minced gels obtained by the gel formation processes with additional plant-based protein isolates, that would gel during cooking.

Equivalent to the concept of using self-gelling alginate to make a gel of MDM, followed by mincing such a gel and combining it with a binding dough to get a homogeneous cooked product having the desired texture, the initial target was to try to make a gelled emulsion with a self-gelling alginate with hydrated texturized soy protein (1 part of texturized soy protein plus 2 parts of water). After mixing the alginate emulsion with the hydrated texturized soy protein, the combined mixture was left overnight at 5° C., (FIG. 1). The gel was then minced and mixed 1:1 with a binding dough containing water and high gelling soy isolate in the ratio 3.2:1 plus colors and flavors. Burgers were formed (113 g) and pan fried to 80° C. in the core, see example 1. The combination of a satisfying strong gel when mixing the self-gelling alginate emulsion with the hydrated texturized soy protein was a surprise, but maybe the texturized soy protein would have a reduced tendency of phase separation (discussed elsewhere in this invention) compared to soy isolate. It was furthermore a surprise that the hydrated textured soy protein chunks were adhering very well to the gelled alginate emulsion with no tendency of “falling out” of the gel.

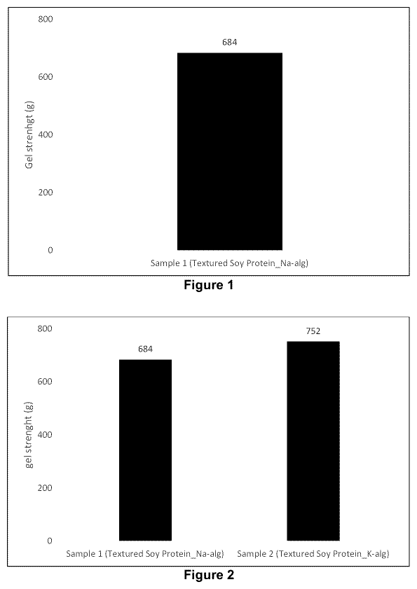

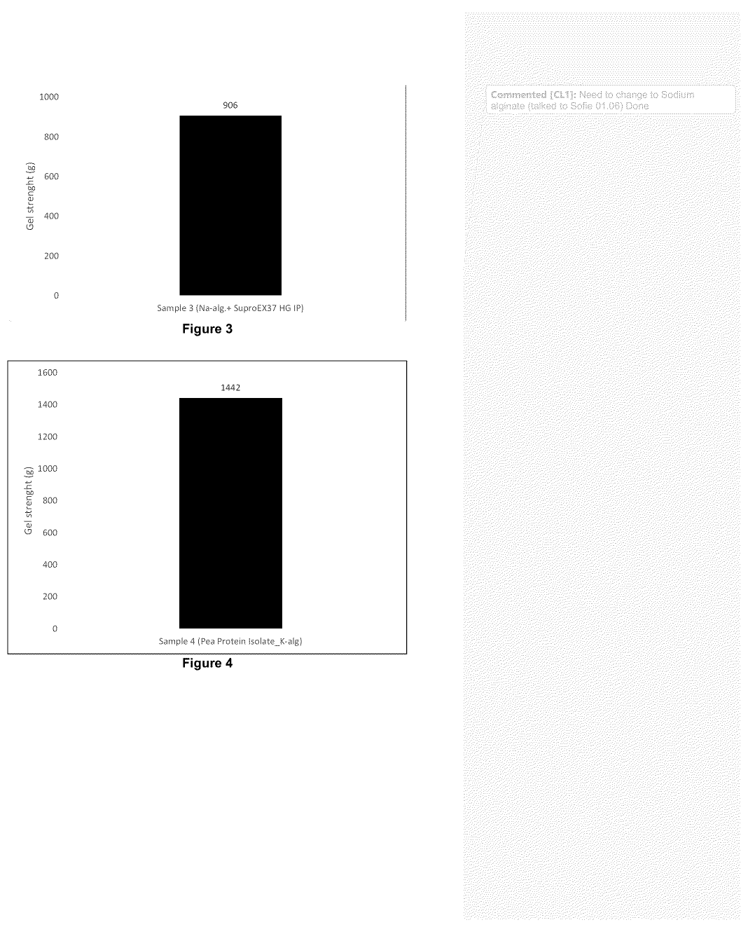

The self-gelling alginate used contained sodium alginate, calcium sulfate and tetrasodium pyrophosphate (TSPP). By replacing the sodium alginate (Na-alginate) with potassium alginate (K-alginate), the strength of the combined mixture was increased, see example 2 and FIG. 2. Using a hydrated soy isolate protein such as SuproEX37 HG IP (1 part of isolated soy protein plus 3.2 parts of water) instead of the textured soy protein data furthermore demonstrated a strong gel formation when the combined mixture was left overnight at 5° C., see example 3 and FIG. 3. This was surprising considering the phase separation issues described elsewhere in this invention. Furthermore, a combined mixture of hydrated pea protein isolate (1 part of pea protein isolate plus 3.2 parts of water) and an alginate system (K-alginate+encapsulated calcium lactate) emulsion also demonstrated strong gel formation when left overnight, see example 4 and FIG. 4.

In this gelling system just described in example 4, the calcium sulphate and TSPP were replaced with encapsulated calcium lactate. When using encapsulated calcium lactate, the calcium source and the slow calcium release are in one component. The encapsulation of the calcium salt will result in slow release of calcium and hence avoid spot gelation or gelation during the mixing sequence, as apparently the encapsulated calcium lactate particle is somewhat porous allowing water to enter into the particle thereby dissociating the calcium lactate also at temperatures below the melting point of the fat used for the encapsulation. Furthermore, by using encapsulated calcium lactate instead of calcium sulphate and TSPP, no phosphate is added and thus, a system free from phosphate was obtained.

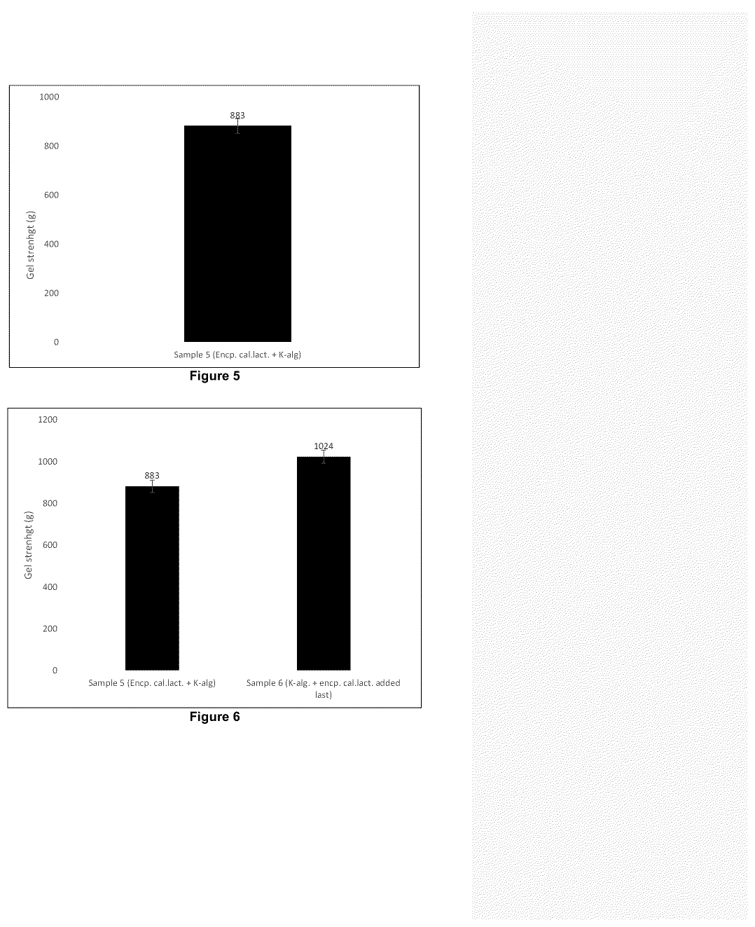

Gel formation using above mentioned phosphate free alginate system also occurred when mixing it with hydrated soy protein and leaving the combined mixture over night at 5° C. (FIG. 5, example 5). In example 5, the K-alginate and encapsulated calcium lactate was dry mixed (1-part alginate to 1.5 parts of encapsulated calcium lactate) and hydrated in water. Slowly the oil was added to make an emulsion. The alginate system emulsion was mixed 1.5:1 with the hydrated pea protein isolate and left over-night at 5° C. Data indicated that when using hydrated pea protein instead of hydrated soy isolate, the strength of the gel was highly increased (compare FIG. 4 to FIG. 5/example 4 and 5).

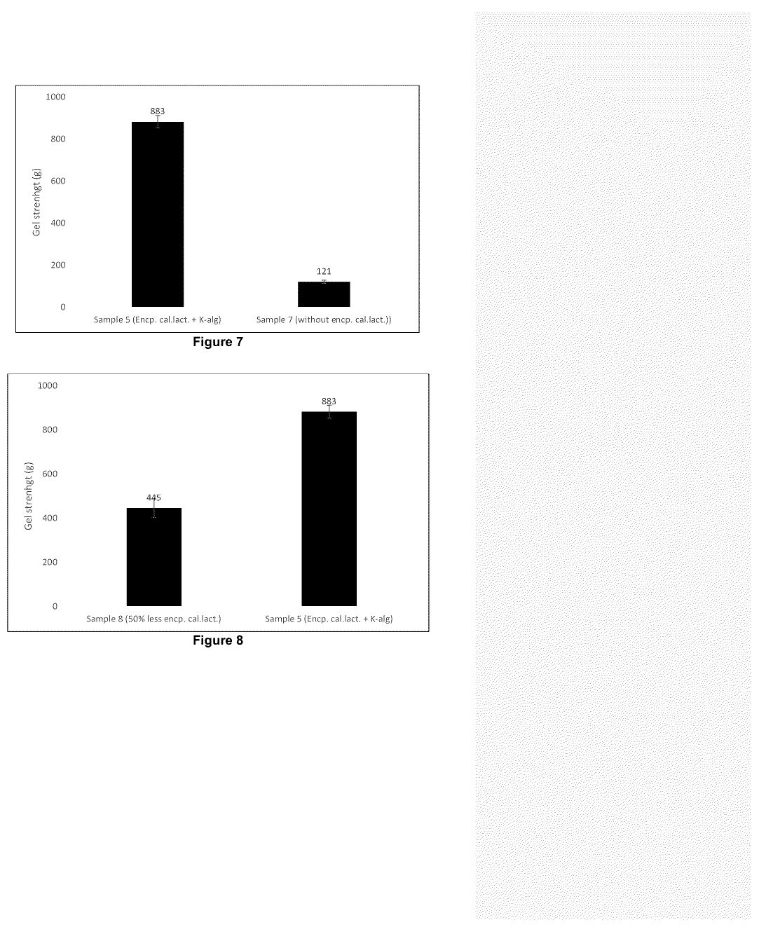

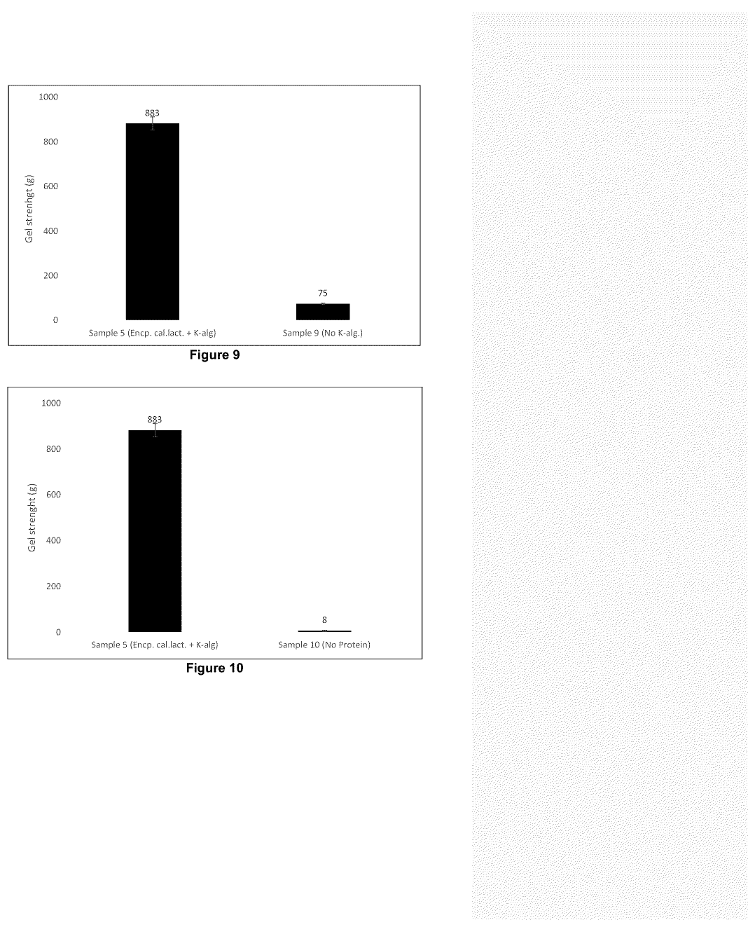

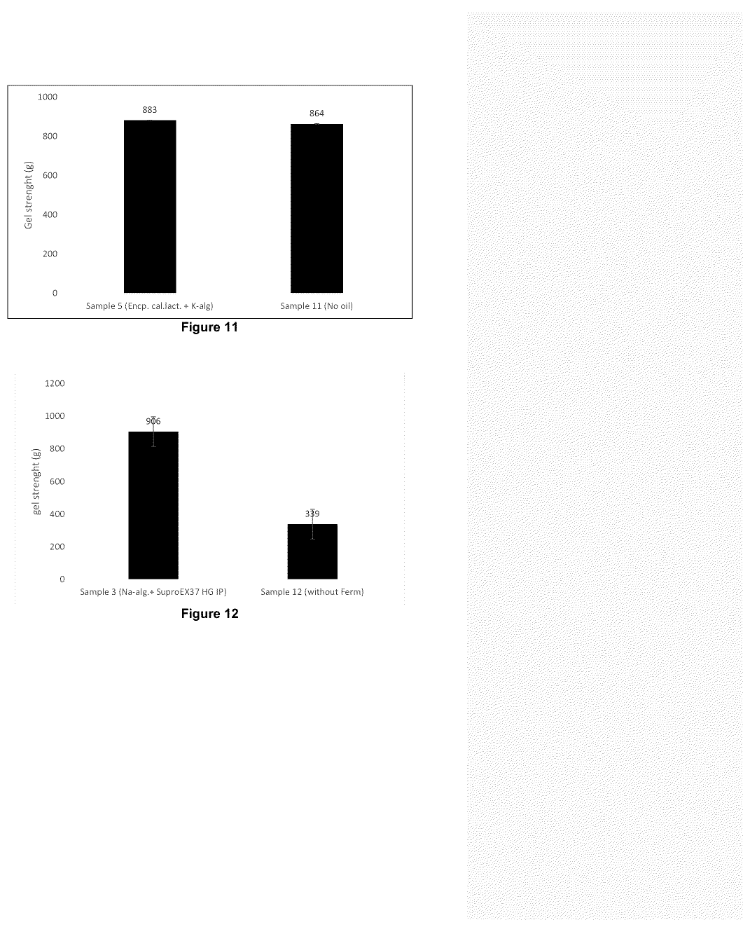

Adding the encapsulated calcium lactate after the alginate emulsion was conducted compared to prior, data demonstrated stronger gel formation, see example 6, see FIG. 6. Gel formation of the combined mixture depended upon the encapsulated calcium lactate. Thus, if the encapsulated calcium lactate was excluded from the experiment, no gel formation occurred, see example 7, see FIG. 7. The strength of the gel formed between the alginate system emulsion and the hydrated soy isolate was increased, as the concentration of the encapsulated calcium lactate was increased, see example 8, see FIG. 8. Thus, increasing the concentration of the encapsulated calcium lactate from 1:1 (alginate:encapsulated calcium lactate) providing the stoichiometric ration between alginate and calcium ions to 1:1.5 (alginate:encapsulated calcium lactate), the gel strength became further strengthened indicating a non-complete accessibility of the calcium ions to the alginate, which is to be expected as the fat matrix does not melt at ambient temperatures or below ambient temperatures. The gel could not be formed, when the alginate salt was not present, see example 9, see FIG. 9. The protein, Supro EX37 HG IP, was likewise required for gel formation to occur, see example 10, see FIG. 10. When the hydration of alginate and the encapsulated calcium lactate was performed without adding the oil, the combined mixture of the alginate system and hydrated isolated soy protein would still result in gel formation when left over night at 5° C., see example 11, see FIG. 11.

By adding 20% fermented dextrose to the self-gelling alginate (Na-alginate+calcium sulfate and TSPP) before hydration, a significantly stronger gel was observed, see example 12, see FIG. 12.

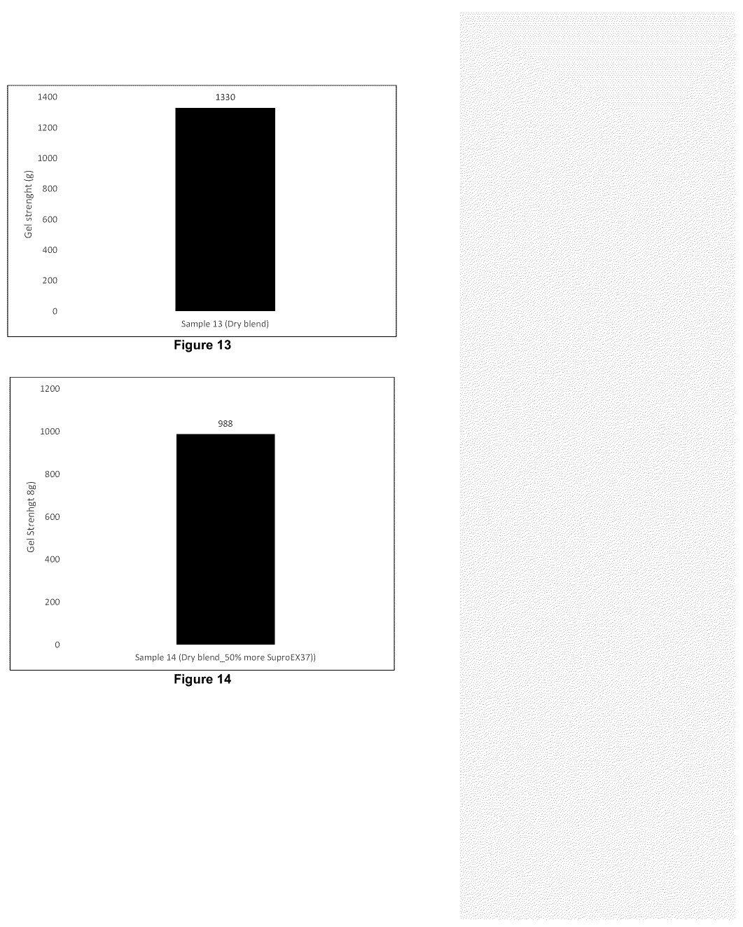

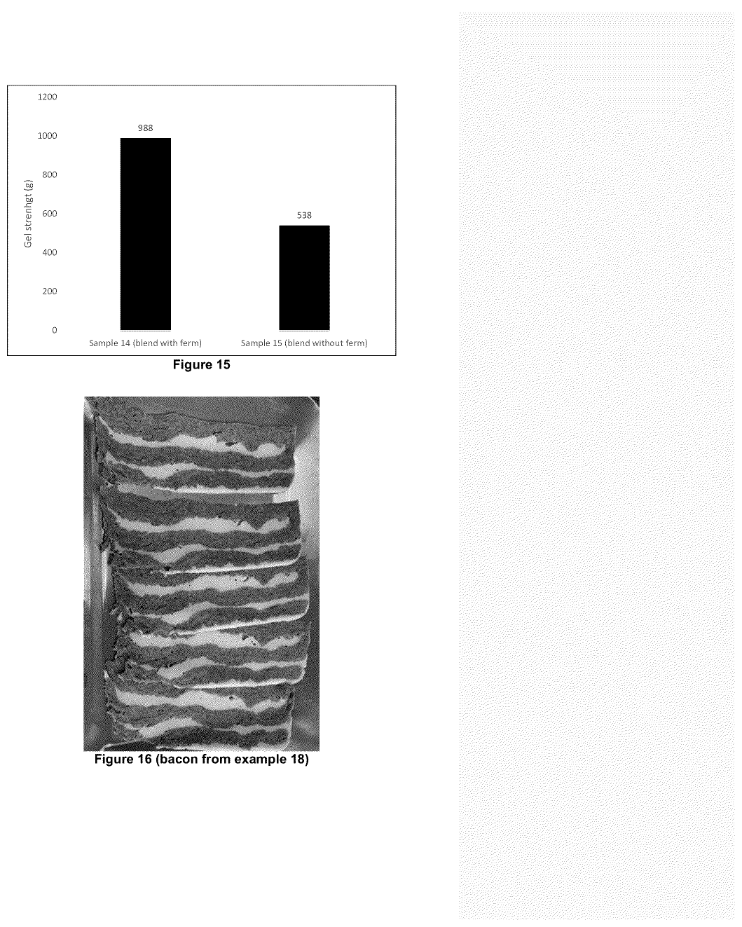

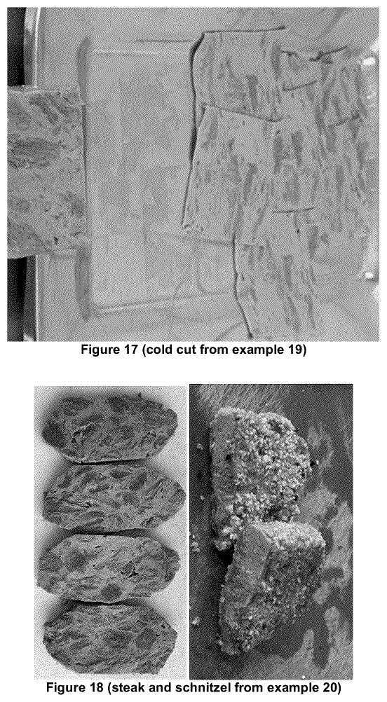

All above mentioned examples use a step-wise approach. Thus, first the self-gelling alginate (Na-alginate+calcium sulphate+TSPP), or the alginate system (K-alginate+encapsulated calcium lactate) was hydrated, and oil was added to conduct an emulsion. Or the alginate was hydrated at first, and then the encapsulated calcium lactate was added (before or after the emulsion had been formed). The hydrated protein was then added to the emulsion and mixed well. By leaving the mixture over night, gel formation occurred. However, to our surprise a strong gel was formed when mixing all the dry ingredients well and hydrate them together. Thus, K-alginate, encapsulated calcium lactate and soy isolate protein were dry mixed and added to the water (1 min). The oil was then added slowly. After 24 hours at 5° C. a strong gel was formed, see example 13, see FIG. 13. A strong gel was also obtained, when the concentration of the protein (isolated soy protein) was increased by 50%, see example 14, see FIG. 14. Lastly, when fermented dextrose was added to the blend, the gel strength was measured to be much stronger as when fermented dextrose was excluded from the dry mix blend, see example 15, FIG. 15.

In summary we surprisingly found that:
it's indeed possible to produce strong gels of alginate and vegetable protein isolates like soy and pea protein isolate without the presence of any animal derived proteins like egg white (albumen).
such alginate/vegetable protein gels exert the desired and necessary texture to be applied both partly and wholly to produce the finished food product.
it's not possible to get the desired gel without the vegetable protein isolates (see FIG. 10, example 8), i.e. all three ingredients are needed to make the gel.
such alginate/vegetable protein formulations can be made to effectively adhere to and bind hydrated textured vegetable protein chunks thereby offering new ways to produce whole muscle type of vegan and vegetarian meat alternative products like bacon (see example 18), cold cuts (see example 19), steaks and schnitzels (see example 20).
a self-gelling system with alginate, protein and encapsulated calcium salt can be made without the use of sequestrants by using an encapsulated calcium salt instead
the encapsulated calcium salt particles are not being destroyed in the bowl chopper procedure needed to make the above meat alternative products, as this would cause the calcium lactate to be more pronouncedly exposed to the water phase thereby quickly dissolving the calcium lactate causing the alginate to gel before the mixing operations have been finalized.

Numbered Embodiments of the Invention:
1. A gelling composition comprising:
   a. a source of at least one plant protein, giving a total amount of protein of from about 1 to about 75 weight % in the composition based on the total weight of the composition;
   b. Salts of alginate in a total amount of about 10 to 75 weight % in the composition based on the total weight of the composition;
   c. Encapsulated Calcium source present from half (w/w) the amount of the alginate to four times the amount of the alginate in the composition.
2. The gelling composition, according to embodiment 1, in which the plant-based protein is selected from isolated soy, isolated pea, texturized soy, texturized pea, wheat, canola, potato, rapeseed or combinations thereof.
3. The gelling composition, according to embodiment 2, in which the plant-based protein is preferably isolated or texturized soy or pea protein or mixtures thereof.
4. The gelling composition, according to any of the preceding claims, in which the plant-based protein concentration is preferably between 5 to 50% by weight of the gelling composition.
5. The gelling composition, according to embodiment 1, in which the salts of alginate is preferably sodium or potassium alginate.
6. The gelling composition, according to any of the preceding embodiments, in which the salts of alginate is present in a preferably an amount between 15 and 40 weight % in the composition based on the total weight of the composition.
7. The gelling composition, according to embodiment 1, in which the encapsulated calcium source is selected from the group of calcium alginate, calcium sulphate, calcium acetate, calcium ascorbate, calcium tartrate, calcium chloride, calcium citrate, di-calcium phosphate and calcium lactate.
8. The gelling composition, according to any of the preceding embodiments, in which the encapsulated calcium source is delivering an amount of calcium corresponding to 7-20% of the alginate content in the composition.
9. The gelling composition, according to any of the preceding embodiment, wherein the composition generates a gel comprising an amount from 5 to 35% of the gelling composition with at least 500 g of gel strength.
10. Dry blend of the gelling composition as described in embodiments 1 to 9, wherein the dry blend is a powder mix of the isolated plant-based protein, salts of alginate and encapsulated calcium lactate, optionally containing fermented dextrose.
11. A gel comprising an amount from 5 to 35% of the gelling composition as described in embodiments 1 to 9, wherein the gel composition has at least 500 g of gel strength breaking point, wherein it is minced without turning it into a paste, wherein the gel does not contain methyl cellulose.
12. The gel, according to embodiment 11, in which the plant-based protein concentration is between 1-30% by weight of the gel.
13. The gel, according to embodiments 11 to 12, in which the plant-based protein is preferably isolated soy or pea protein.
14. The gel, according to embodiments 11 to 12, in which the plant-based protein is preferably texturized soy or pea protein.
15. The gel composition, according to embodiments 11 to 14, in which the salts of alginate is present in an amount of 0.5-5.0% by weight of the gel.
16. The gel, according to embodiments 11 to 15, in which the encapsulated calcium lactate is present in an amount of 1-8% by weight of the obtained gel.
17. The gel, according to embodiments 11 to 16, in which the composition may optionally contain fermented dextrose in an amount of 0.5-2.5% by weight of the obtained gel in high gel strength applications.
18. A process for producing the gel as described in embodiments 11 to 17, using the gelling composition as described in embodiments 1 to 9 or embodiment 10, comprising the steps of:
   i) hydrating the blend of isolated plant-based protein, salts of alginate and calcium source;
   j) adding oil to turn the product obtained from step a) into an alginate emulsion;
   k) hydrating the texturized plant-based protein;
   l) mixing the hydrated protein from step c) with the alginate emulsion from step b);
   m) leaving the mixture of step d) for gelling at refrigeration temperature for minimum 3 hours;
   n) the gel obtained in step e) can be additionally minced;
   o) The gel obtained in step e) can constitute the finished product, which could be frozen or sliced or diced or cooked followed by cooling and slicing;
   p) The mixture obtained in step d) can be cooked to make the finished gelled food product (cold cut).
19. A plant-based food product containing the gel as described in embodiments 11 to 15 obtained by the gelling composition as described in embodiments 1 to 9 or embodiment 10, in amounts of 10-100% of the plant-based food product.
20. The plant-based food product according to embodiment 19, wherein the product could be a burger, sausage, nuggets, dices for pizza toppings or salads, bacon slices, steaks, schnitzels and the like.
21. A process for obtaining a plant-based food product of embodiments 19 to 20, wherein the gelling composition as described in embodiments 1 to 10 is added and mixed into the final food product mixture prior to forming the finished uncooked food product.
22. Process for obtaining a plant-based food product containing the gelling composition described in embodiments 1 to 10, in which the obtained gels of embodiments 13 and 14, can be placed in different layers prior to gelation to form the final food product.

### EXPERIMENTAL SECTION

### General Description of Material and Methods

Texture Analyser

A texture analyser (TA/TX2 with 12.7 mm probe, distance 20 mm, speed 0.5 mm/s) has been used to measure strength of the formed gel between self-gelling alginate/alginate system and plant-based proteins.

A gel strength test measures the amount of force needed to rupture a specimen gel and the extension at rupture reported. In this case the functional system was utilised in the formation of a gel, in the presence of an alginate, calcium source, sequestrant and a protein.

The formed gels consisted of different concentration of alginate, alginate type, different calcium sources and sequestrant as well as different proteins.

Test Procedure

Method 1—Stepwise Addition of Ingredients

Below the standard method for step-wise addition is described. This method was modified during experimental progress as shown by descriptions belonging to the embodiments.

Weigh 7,3 g of alginate self-gelling blend with 20% Ferm (5,16 g self-gelling alginate+2,15 g fermented dextrose) (all weights to be measure accurately to+0.01 g). Weigh 85,8 g tap water into a 250 ml thick beaker glass. Weight 28,68 g of sunflower oil.

Place the beaker on a high speed stirrer fitted with a four blade propeller and stir at 1400 rpm +20 rpm to create a vortex.

Quickly disperse the test mixture in the water by adding down the wall of the vortex and start the timer. Continue mixing for 1 minutes. Slowly add the oil during 1 min. Continue stirring for 1 more minute. While stirring the last minute, hydrate 20 g of the plant-based protein in 60 ml tap water.

Remove from the stirrer and mix the mixture with the hydrated protein using a handhold mixer. Mix the solution for 1 min. Deposit the solution into a 200 ml gel pot beakers. Cover the beaker with a plastic lid and leave undisturbed for 24 hours at 5° C. Record the gel profile after 24 hours using the TA/TX2 analyser—12.7 mm probe, speed 0.5 mm/s to a depth of 20 mm.

Method 2—Dry Mix Blend of Ingredients

Below the standard method for step-wise addition is described. This method was modified during experimental progress as shown by descriptions belonging to the embodiments.

Weigh 7,3 g of alginate self-gelling blend/phosphate free alginate system with 20% fermented dextrose and mix well with 20 g of protein (all weights to be measure accurately to+0.01 g). Weigh 143 g tap water into a 250 ml thick beaker glass. Weight 28,68 g of sunflower oil.

Place the beaker on a high speed stirrer fitted with a four blade propeller and stir at 1400 rpm +20 rpm to create a vortex.

Quickly disperse the test mixture in the water by adding down the wall of the vortex and start the timer. Continue mixing for 1 minutes. Slowly add the oil during 1 min. Continue stirring for 1 more minute.

Remove from the stirrer and deposit the solution into a 200 ml gel pot beakers. Cover the beaker with a plastic lid and leave undisturbed for 24 hours at 5 degrees celsius. Record the gel profile after 24 hours using the TA/TX2 analyser—12.7 mm probe, speed 0.5 mm/s to a depth of 20mm.

Results

For FIG. 1-15, black bars represent the measured gel strength (maximum force, g) of the gel between the combined mixture consisting of hydrated gelling alginate emulsion and hydrated protein. All measurements were performed after the combined mixture had been left alone for 24 hours at 5° C.

For all figures the following applies:
Ferm refers to fermented dextrose
Na-alg. refers to sodium alginate
K-alg refers to potassium alginate
Encp. cal. Lact refers to encapsulated calcium lactate
Dry blend refers to the process where all ingredients were mixed dry and hydrated together.

Data demonstrates that it was possible to conduct a strong gel between hydrated textured soy protein (SuproMax5010) and an emulsion of self-gelling sodium alginate (sodium alginate+calcium sulfate+TSPP with fermented dextrose) (684 g), n=1 (FIG. 1). Using potassium alginate instead of sodium alginate resulted in increased gel strength (Sodium alginate 684 g vs potassium alginate 752 g), n=1 (FIG. 2). Gel formation similarly occurred using isolated soy protein (Supro EX37 HG IP) (906 g), n=1 (FIG. 3) as well as pea isolate protein (Trupro 2000) (1442 g), n=1 (FIG. 4).

When using an alginate system free from phosphate, thus alginate and encapsulated calcium lactate, a strong gel was likewise observed (883 g +/−29) (FIG. 5) that further strengthens to 1024 (+/−31) when adding encapsulated calcium lactate after the emulsion was performed (FIG. 6). Data also illustrated that using pea protein isolate instead of isolated soy protein, gel strength of the combined mixture was increased (1442 g for pea vs 883 g for soy).

Furthermore, data demonstrated that gel formation depended upon all ingredients since no gel was formed without encapsulated calcium lactate (121 g, +/−8) (FIG. 7), without alginate (75+/−3) (FIG. 9) nor without the protein (suproEX37 HG IP) (8 g +/−o) (FIG. 10). However, gel formation does not depend upon oil (864 g) (FIG. 11). Furthermore, increasing the amount of encapsulated calcium lactate from 1:1 (alginate:encapsulated calcium lactate) to 1:1.5 (alginate:encapsulated calcium lactate) the strength of the gel increased from 445 g (+/−42) to 883 (+/−29) g, n=6 (FIG. 8).

The strength of the gel was highly increased when fermented dextrose was added to the self-gelling alginate; 339 g without fermented dextrose (FIG. 3) vs 906 g with fermented dextrose, n=1 (FIG. 12).

Using a dry blend mix of all ingredients hydrated together, gel strength was measured to 1330 g (FIG. 13), n=1. Adding 50% more protein, a strong gel was also demonstrated (988 g), n=1 (FIG. 14). Lastly, data verified that when adding fermented dextrose to the dry blend mix as well, also resulted in stronger gel formation (538 g), n=1 (FIG. 15). For a compiled overview of the different samples and corresponding gel strength (g) as well as distance (mm) see table 1.

Table 1 provides an overview of samples and associated gel strength and distance:

| | | Gel | |
|---|---|---|---|
| | | strength | Dis- |
| Sample | | (maxi- | tance, |
| # | Ingredients | mum), g | mm |
| 1 | Self-gelling sodium alginate emulsion with | 684 | 8.8 |
| | fermented dextrose | | |
| | SuproMax5010 (textured soy protein) | | |
| 2 | Self-gelling potassium alginate emulsion | 752 | 10.00 |
| | with fermented dextrose | | |
| | SuproMax5010 (textured soy protein) | | |
| 3 | Self-gelling potassium alginate emulsion | 906 | 16.36 |
| | with fermented dextrose | | |
| | SuproEX 37 HG IP (isolated soy protein) | | |
| 4 | K-alginate + encapsulated calcium lactate | 1442 | 7.36 |
| | emulsion | | |
| | Trupo 2000 (Pea isolate protein) | | |
| 5 | K. alginate + encapsulated calcium lactate | 883 | 9.92 |
| | emulsion | | |
| | SuproEX 37 HG IP (isolated soy protein) | | |
| 6 | K. alginate + encapsulated calcium lactate | 1024 | 9.37 |
| | emulsion (encapsulated calcium lactate | | |
| | added last) | | |
| | SuproEX 37 HG IP (soy isolate protein) | | |
| 7 | K-alginate (NO encapsulated calcium lactate) | 121 | 19.41 |
| | emulsion | | |
| | SuproEX 37 HG IP (isolated soy protein) | | |
| 8 | K. alginate + 50% less encapsulated calcium | 445 | 9.5 |
| | lactate emulsion | | |
| | SuproEX 37 HG IP (isolated soy protein) | | |
| 9 | encapsulated calcium lactate emulsion (NO | 75 | 19.3 |
| | K-alginate) | | |
| | SuproEX 37 HG IP (isolated soy protein) | | |
| 10 | K. alginate + encapsulated calcium lactate | 8 | 19 |
| | emulsion | | |
| | (NO soy isolate protein) | | |
| 11 | K.-alginate + encapsulated calcium lactate | 864 | 8.4 |
| | (NO oil = no emulsion) | | |
| | SuproEX 37 HG IP (isolated soy protein) | | |
| 12 | Self-gelling sodium alginate emulsion | 339 | 16 |
| | without fermented dextrose | | |
| | SuproEX 37 HG IP (isolated soy protein) | | |
| 13 | Dry blend mix of K-alginate + encapsulated | 1330 | 9.4 |
| | calcium lactate + SuproEX 37 HG IP (soy | | |
| | isolate protein) + fermented dextrose | | |
| 14 | Dry blend mix of K- alginate + encapsulated | 988 | 8.4 |
| | calcium lactate + 50% more SuproEX 37 HG | | |
| | IP (isolated soy protein) + fermented | | |
| | dextrose | | |
| 15 | Dry blend mix of K. alginate + encapsulated | 538 | 10 |
| | calcium lactate + 50% more SuproEX 37 HG | | |
| | IP (isolated soy protein) (No fermented | | |
| | dextrose) | | |

The table 2 shows % of added ingredients in the finished gel/combined mixture

| | Water | Protein | Alginate/alginate | encapsulated | Water | FERM | Oil |
|---|---|---|---|---|---|---|---|
| | % | % | blend % | calcium lactate % | % | % | % |
| Sample # | Step 1 - protein hydration | | Step 2 - alginate emulsion | | | | |
| Sample | 22 | 11 | 3.24 alginate | — | 48 | 0.8 | 15 |
| 1 | | (SuproMax5010) | blend | | | | |
| | | | (=1.62 Na-alg.) | | | | |
| Sample | 22 | 11 | 3.24 alginate | — | 48 | 0.8 | 15 |
| 2 | | (SuproMax5010) | blend | | | | |
| | | | (1.62 K-alg.) | | | | |
| Sample | 30 | 10 | 2.56 | — | 42 | 1 | 14 |
| 3 | | (SuproEX37 HG | (=1.28 K.-alg) | | | | |
| | | IP) | | | | | |
| Sample | 30 | 10 | 1.28 | 2.13 | 42 | — | 14 |
| 4 | | (Trupo 2000) | (K. alg) | | | | |
| Sample | 30 | 10 | 1.28 | 2.13 | 43 | — | 15 |
| 5 | | (SuproEX37 HG | (K. alg) | | | | |
| | | IP) | | | | | |
| Sample | 30 | 10 | 1.28 | 2.13 | 43 | — | 15 |
| 6 | | (SuproEX37 HG | (K. alg) | | | | |
| | | IP) | | | | | |
| Sample | 30 | 10 | 1.3 | — | 43 | — | 15 |
| 7 | | (SuproEX37 HG | (K. alg) | | | | |
| | | IP) | | | | | |
| Sample | 30 | 10 | 1.29 | 1.29 | 43 | — | 15 |
| 8 | | (SuproEX37 HG | (K. alg) | | | | |
| | | IP) | | | | | |
| Sample | 30 | 10 | — | 2.16 | 43 | — | 15 |
| 9 | | (SuproEX37 HG | (No K. alg) | | | | |
| | | IP) | | | | | |
| Sample | 33 | — | 1.4 | 2.4 | 47 | — | 16 |
| 10 | | | (K. alg) | | | | |
| Sample | 35 | 12 | 1.5 | 1.5 | 50 | — | — |
| 11 | | (SuproEX37 HG | (K. alg) | | | | |
| | | IP) | | | | | |
| Sample | 30 | 10 | 2.5 blend | — | 43 | — | 14 |
| 12 | | (SuproEX37 HG | (=1.28% Na. alg.) | | | | |
| | | IP) | | | | | |
| Sample | 30 | 10 | 1.28 | 2.14 | 43 | 0.8 | 14 |
| 13 | | (SuproEX37 HG | (K. alg) | | | | |
| | | IP) | | | | | |
| Sample14 | 28 | 14 | 1.22 | 2.03 | 41 | 0.8 | 14 |
| | | (SuproEX37 HG | (K. alg) | | | | |
| | | IP) | | | | | |
| Sample | 28 | 14 | 1.22 | 2.03 | 41 | | 14 |
| 15 | | (SuproEX37 HG | (K. alg) | | | | |
| | | IP) | | | | | |

Table 3 illustrates ratio between alginate emulsion and hydrated protein

| | Alginate emulsion:hydrated | Alginate:Encapsulated |
|---|---|---|
| | protein | calcium lactate |
| Sample 1 | ~2:1 | — |
| | | (self-gelling alginate used) |
| Sample 2 | ~2:1 | — |
| | | (self-gelling alginate used) |
| Sample 3 | 1.5:1 | — |
| | | (self-gelling alginate used) |
| Sample 4 | 1.5:1 | 1:1.5 |
| Sample 5 | 1.5:1 | 1:1.5 |
| Sample 6 | 1.5:1 | 1:1.5 |
| Sample 7 | 1.5:1 | No MT230 |
| Sample 8 | 1.5:1 | 1:1 |
| Sample 9 | 1.5:1 | No alginate |
| Sample 10 | No protein | 1:1.5 |
| Sample 11 | 1.2:1 | 1:1.5 |
| Sample 12 | 1.5:1 | — |
| | | (self-gelling alginate used) |
| Sample 13 | 1.5:1 | 1:1.5 |
| Sample 14 | 1.3:1 | 1:1.5 |
| Sample 15 | 1.3:1 | 1:1.5 |

Embodiment 1—Self-Gelling Alginate (Na-Alginate, CaSO4, TSPP) Emulsion can be Gelled with a Textured Soy Protein (Supromax 5010), a Soy Isolate Protein (Supro EX 37 HG IP), a as well as Pea Protein Isolate (Trupo 2000) with an Alginate System (Alginate+Encapsulated Calcium Lactate):

Example 1—Self-Gelling Alginate with Fermented Dextrose Emulsion can be Gelled with Textured Soy Protein (Supromax 5010).

Add 2 kg textured soy protein (Supromax 5010) to a vacuum bag. Then add 4 kg of water to the bag. Draw vacuum on the bag and hydrate for min. 30 minutes. Add 4290 grams of water to the bowl chopper. Then add 365 grams of self-gelling alginate (Na-alginate, CaSO4, TSPP)/fermented dextrose blend (80% Protanal ME 6240+20% fermented dextrose) to the chopper and chop at full speed of bowl and knives for one minute while scraping the sides. Then add 1345 grams of rapeseed oil slowly (for 1 minute) while chopping at full speed. Then chop 1 minute more at full speed under vacuum. Then add 3 kg of hydrated textured protein (Supromax 5010) to the chopper, and chop at full speed of bowl and knives 2000 rpm under vacuum for 1 minute. Empty the chopper and leave the mixture overnight at 5° C. (FIG. 1). Grind the gelled material on 11 mm plate. Prepare binding dough: Add 4331 gram of water/Ice (2:1) to the chopper. Then add 1354 grams of soy isolate (Supro EX 37 HG IP) and chop at full speed of bowl and knives for two minutes. Add the remaining ingredients (45 grams fermented dextrose, 117 grams colors, 152 grams of spices and salt) and chop at full speed of bowl and knives for one minute plus 1 minutes under vacuum. Combine 500 grams of the minced gelled material with 500 grams of the binding dough in a Hobart mixer and mix for 30 seconds on step 1. Form 113 grams burgers and pan fry to 80° C. in the core.

Example 2—Potassium Alginate Increases Gel Strength Compared to Sodium Alginate.

The procedure described in EX.1. was used replacing the self-gelling alginate (Na-alginate, CaSO4, TSPP)/fermented dextrose blend (80% Protanal ME 6240+20% fermented dextrose) with self-gelling alginate (K-alginate, CaSO4, TSPP)/fermented dextrose blend (80% (K-alginate, CaSO4, TSPP)+20% fermented dextrose) (FIG. 2).

Example 3—Self-Gelling Alginate with Fermented Dextrose (Na-Alginate, CaSO4, TSPP) Emulsion can be Gelled with Soy Isolate Protein (Supro EX 37 HG IP).

Weigh 5,16 g self-gelling alginate, Protanal ME 6240, and mix with 2,15 g fermented dextrose (all weights to be measure accurately to+0.01 g). Weigh 85,58 g tap water into a 250 ml thick beaker glass. Weight 28,68 g of sunflower oil. Place the beaker on a high-speed stirrer fitted with a four-blade propeller and stir at 1400 rpm+20 rpm to create a vortex. Quickly disperse the test mixture in the water by adding down the wall of the vortex and start the timer. Continue mixing for 1 minutes. Slowly add the oil during 1 min. Continue stirring for 1 more minute. While stirring the last minute, hydrate 20 g of the plant-based protein in 60 ml tap water. Remove from the stirrer and mix the mixture with the hydrated protein using a handhold mixer. Mix the solution for 1 min. Deposit the solution into 200 ml gel pot beakers. Cover the beaker with a plastic lid and leave undisturbed for 24 hours at 5° C. Record the gel profile after 24 hours using the TA/TX2 analyser—12.7 mm probe, speed 0.5 mm/s to a depth of 20 mm (FIG. 3).

Example 4—A Gelling Alginate System Emulsion can be Gelled with Isolated Pea Protein.

The procedure described in EX.5. was used. However, pea protein isolate (Trupo 2000) was used instead of soy isolate proteins (FIG. 4).

Embodiment 2—Self-Gelling Alginate (Alginate+Encapsulated Calcium Lactate) Emulsion can be Gelled with Isolated Soy Protein (SuproEX37 HG IP):

Example 5—an Emulsion of a Phosphate Free Alginate System (Potassium Alginate+Encapsulated Calcium Lactate) can be Gelled with a Soy Isolate Protein (SuproEX37 HG IP).

Weigh 2,58 g of K-alginate and 4,3 g of encapsulated calcium lactate (all weights to be measure accurately to+0.01 g) and mixed well in a small bag. Weigh 83,58 g tap water into a 250 ml thick beaker glass. Weight 28,68 g of sunflower oil. Place the beaker on a high-speed stirrer fitted with a four-blade propeller and stir at 1400 rpm+20 rpm to create a vortex. Quickly disperse the test mixture in the water by adding down the wall of the vortex and start the timer. Continue mixing for 1 minutes. Slowly add the oil during 1 min. Continue stirring for 1 more minute. While stirring the last minute, hydrate 20 g of the plant-based protein in 60 ml tap water. Remove from the stirrer and mix the mixture with the hydrated protein using a handhold mixer. Mix the solution for 1 min. Deposit the solution into 200 ml gel pot beakers. Cover the beaker with a plastic lid and leave undisturbed for 24 hours at 5° C. Record the gel profile after 24 hours using the TA/TX2 analyser—12.7 mm probe, speed 0.5 mm/s to a depth of 20 mm (FIG. 5).

Example 6—When Encapsulated Calcium Lactate was Added After Confirmation of the Alginate Emulsion a Stronger Gel was Achieved.

The procedure described in EX.5. was used. However, instated of mixing K-alginate with encapsulated calcium lactate at first, the encapsulated calcium lactate was sprinkled over the emulsion (FIG. 6).

Example 7—Gel Formation Requires the Presence of Encapsulated Calcium Lactate.

The procedure described in EX.5. was used. However, the encapsulated calcium lactate was excluded from the process (FIG. 7).

Example 8—the Gel Strength Increases as Concentration of Encapsulated Calcium Lactate Increases.

The procedure described in EX.5. was used. However, 2,58 g of encapsulated calcium lactate was used instead of the standard 4,3 g (FIG. 8).

Example 9—Gel Formation Requires the Present of Alginate (Thus, SuproEX37 HG IP is not Solely Responsible for Gel Formation).

The procedure described in EX.5. was used leaving out K-alginate in the experimental procedure (FIG. 9).

Example 10—Isolated Soy Protein (SuproEX 37 HG IP) is Required to Facilitate Gel Formation Using Encapsulated Calcium Lactate.

The procedure described in EX.5. was used leaving out the soy isolate, SuproEX37 HG IP, in the experimental procedure (FIG. 10).

Example 11—an Emulsion is not Needed for Gel Formation to Occur.

Thus, the gel can be form without the presence of oil. The procedure described in EX.5. was used leaving out the oil in the experimental procedure (FIG. 11).

Embodiment 3—Fermented Dextrose Significantly Increases Gel Strength Using Self-Gelling Alginate (Alginate+Calcium Sulfate+TSPP):

Example 12—Fermented Dextrose Increases Gel Strength Using Self-Gelling Alginate.

The procedure described in EX.3. was used. However, to demonstrate the positive effect of fermented on gel strength, in this example the 2,15 g fermented dextrose was not included (FIG. 12).

Embodiment 4—a Dry Blend Mix of Alginate, Encapsulated Calcium Lactate and SuproEX37 HG IP Results in a Strong Gel

Example 13—a Dry Blend Mix of Alginate, Encapsulated Calcium Lactate and SuproEX37 HG IP Results in a Strong Gel.

The procedure described in EX.5. was used. However, instead of step-by step approach, K-alginate, encapsulated calcium lactate, SuproEX37 HG IP and fermented dextrose were mixed well and added together to the water (FIG. 13).

Example 14—the Gel Strength Depends on Protein Concentration.

The procedure described in EX.13. was used. However, instead of 20 g of SuproEX37 HG IP, 30 grams of SuproEX 37 HG IP was added (FIG. 14).

Embodiment 5—Fermented Dextrose Increases Gel Strength Using Dry Blend Mix of Alginate, Encapsulated Calcium Lactate and SuproEX37 HG IP

Example 15—a Dry Blend Mix of Alginate, Encapsulated Calcium Lactate and SuproEX37 HG IP and Fermented Dextrose Increases Gel Strength.

The procedure described in EX.14 was used. However, in sample 15 fermented dextrose was not excluded to demonstrate the positive effect on strength of the gel, when fermented dextrose added (FIG. 15).

Example 16—a Dry Blend Mix of Alginate, Encapsulated Calcium Lactate and SuproEX37 Used to Produce a Gelled Vegetable Oil to be Used in Vegan Bacon.

Add 2880g of water to the bowl chopper. Combine 120 g of pea protein isolate (Trupro 2000) plus 84 g of potassium alginate plus 168 g of encapsulated calcium lactate (Textureze MT 230) into a homogeneous blend and submerge the powder blend in the water while chopping at 1000 rpm of the knives and 25 rpm of the bowl. When submerged chop 1 minute at 2000 rpm of knives and 25 rpm of the bowl, while scraping the bowl. Then turn up the speed to maximum (5400 rpm for the knives and 25 rpm for the bowl) and start immediately pouring in 2748 g of rapeseed oil during 30-60 seconds. Then open the chopper and scrape down. Chop 1 min more at 5400 rpm for the knives and 25 rpm for the bowl under vacuum. Empty into a tray for gelling over night at 5° C. or use it immediately before onset of the gelling for the preparation of the vegan bacon (example 18).

Example 17—Preparation of a Meat Alternative Protein Block for the Preparation of Bacon, Pizza Topping, Salad Topping/Inclusion, Cold Cut, Steak and Battered Schnitzels.

Add 3915 g of water/ice (75/25) and 420 g of rapeseed oil to the chopper. Then solubilize 811.8 g of pea protein isolate (Trupro 2000) at full speed of knives and bowl (5400 rpm/25 rpm) for one minute. Scrape down. Then add the desired colours and spices and chop 2 minutes at full speed of knives and bowl. Scrape down. Combine 208.2 g of pea protein isolate (Trupro 2000) plus 147.6 g of potassium alginate plus 295.2 g of encapsulated calcium lactate (Textureze MT 230) into a homogeneous blend and add the blend while chopping at 1000 rpm for the knives and 25 rpm for the bowl until submerged. Then chop at 3000 rpm for the knives and 25 rpm for the bowl for 1 minute. Scrape down and chop 30 seconds more at 3000 rpm for the knives and 25 rpm for the bowl. Now take out 2 kg from the chopper leaving 4 kg in the chopper. Now add 4 kg of textured vegetable soy protein (Supromax 6550, which has been hydrated 1:2 for at least 30 minutes under vacuum with the desired colours and spices included in the hydration water) while mixing with the knives rotating backwards at 500 rpm and 25 rpm for the bowl for one minute under vacuum. Empty the chopper and allow to gel overnight at 5° C., or use it immediately prior to onset of the gelling for the preparation of vegan bacon.

Example 18—Preparation of Vegan Bacon.

Take 600 gram from trial 16 and place it in smooth layer in a suitable container for making a bacon size block. Take 700 gram from trial 17 and put it on top of the fat emulsion in the container also in a smooth uniform layer so that it is completely submerged into the fat emulsion. Then place another 700 gram of trial 17 on top. Put on a light pressure and leave to gel overnight at 5° C. The next day the bacon can be sliced or diced. See FIG. 16.

Example 19—Cold Cut.

The protein gel block prepared in example 17 can be put in a vacuum bag and cooked in the oven at 80° C. to a core temperature of 75° C. After cooling down to 5° C., the protein block can be sliced for delicate sandwich inlays. See FIG. 17.

Example 20—Steaks and Battered Schnitzels, Bacon, Pizza Toppings, Salad Topping.

The protein gel block prepared in example 17 can be sliced in steak and schnitzel (see FIG. 18) suitable thickness and frozen or fried with and without batter on a pan or in a deep fat fryer. Furthermore, the protein gel block can be sliced into 1-2 mm slices and fried on a pan or in the deep fat fryer to produce bacon type snacks. Furthermore, the protein gel block can be diced for pizza toppings or salad topping.

Example 21—Burger with the Self-Gelling Alginate System in the Binding Dough.

Add 4516 g of water/ice (75/25) and 840 g of rapeseed oil to the chopper. Then solubilize 683.9 g of pea protein isolate (Trupro 2000) at full speed of knives and bowl (5400 rpm/25 rpm) for one minute. Scrape down. Then add the desired colours and chop 2 minutes at full speed of knives and bowl. Scrape down. Combine 296.1 g of pea protein isolate (Trupro 2000) plus 210 g of potassium alginate plus 420 g of encapsulated calcium lactate (Textureze MT 230) into a homogeneous blend and add the blend while chopping at 1000 rpm for the knives and 25 rpm for 10 seconds. Then chop at 3000 rpm for the knives and 25 rpm for the bowl for 1 minute. Scrape down and chop 30 seconds more at 3000 rpm for the knives and 25 rpm for the bowl under vacuum. Now take out 4.5 kg from the chopper leaving 2.5 kg in the chopper. Now add 3 kg of textured vegetable soy protein (Truprotex 4650, which has been hydrated 1:2.5 for at least 30 minutes with the desired colours and spices included in the hydration water) as well as 492 g frozen and minced (5 mm plate) coconut fat while mixing with the knives rotating backwards at 500 rpm and 25 rpm for the bowl for one minute. Form immediately the burgers.

Conclusions on Results

The present invention provides a composition with strong gel formation, resulting in a product which can be minced without creating a paste. The solution was achieved between the combined mixture of alginate emulsion and plant-based proteins. The preferred plant-based proteins, not limiting, are shown in the examples, includes textured soy protein (FIG. 1), isolated soy protein (FIG. 3) as well as a pea protein isolate (FIG. 4).

As shown in the results, data indicated that pea protein was responsible for a stronger gel conformation (FIG. 4 vs FIG. 5).

Gel formation also occurred when mixing all dry ingredients (FIG. 13). When protein concentration was increased with 50%, data revealed consistent gel strength (FIG. 14). When fermented dextrose was added to the dry mix blend, gel strength increases as well (FIG. 15).

Gel formation depended on encapsulated calcium lactate (FIG. 7), alginate (FIG. 9) and the protein (FIG. 10). However, gel formation did not depend on addition of oil (FIG. 11).

Gel strength increases using potassium alginate instead of sodium alginate (FIG. 2), if Encapsulated calcium lactate was added after formation of an emulsion of alginate (FIG. 6), when fermented dextrose was added to the self-gelling alginate (FIG. 12) and as well as when the concentration of encapsulated calcium lactate increases (FIG. 8).

1. A gelling composition comprising:
a. a source of at least one plant protein, giving a total amount of protein of from about 1 to about 75 weight % in the composition based on the total weight of the composition;
b. salts of alginate in a total amount of about 10 to 75 weight % in the composition based on the total weight of the composition; and
c. encapsulated Calcium source present from half (w/w) the amount of the alginate to four times the amount of the alginate in the composition.

2. The gelling composition, according to claim 1, in which the plant-based protein is selected from isolated soy, isolated pea, texturized soy, texturized pea, wheat, canola, potato, rapeseed and combinations thereof.

3. The gelling composition, according to claim 2, in which the plant-based protein is isolated or texturized soy or pea protein or mixtures thereof.

4. The gelling composition, according to claim 1, in which the plant-based protein concentration is preferably between 5 to 50% by weight of the gelling composition.

5. The gelling composition, according to claim 1, in which the salts of alginate comprise sodium or potassium alginate.

6. The gelling composition, according to claim 1, in which the salts of alginate are present in an amount between 15 and 40 weight % in the composition based on the total weight of the composition.

7. The gelling composition, according to claim 1, in which the encapsulated calcium source is selected from the group of calcium alginate, calcium sulphate, calcium acetate, calcium ascorbate, calcium tartrate, calcium chloride, calcium citrate, di-calcium phosphate and calcium lactate.

8. The gelling composition, according to claim 1, in which the encapsulated calcium source is delivering an amount of calcium corresponding to 7-20% of the alginate content in the composition.

9. The gelling composition, according to claim 1, wherein the composition generates a gel comprising an amount from 5 to 35% of the gelling composition with at least 500 g of gel strength.

10. Dry blend of the gelling composition as described in claim 1, wherein the dry blend is a powder mix of the isolated plant-based protein, salts of alginate and encapsulated calcium lactate.

11. A gel, wherein the gel:
comprises from 5 to 35% of the gelling composition as described in claim 1,
has at least 500 g of gel strength breaking point, and
is minced and not a paste, and
does not contain methyl cellulose.

12. The gel, according to claim 11, in which the plant-based protein concentration is between 1-30% by weight of the gel.

13. The gel, according to claims 11, in which the plant-based protein is isolated soy or pea protein.

14. The gel, according to claims 11, in which the plant-based protein is preferably texturized soy or pea protein.

15. The gel, according to claims 11, in which the salts of alginate are present in an amount of 0.5-5.0% by weight of the gel.

16. The gel, according to claims 11, in which the encapsulated calcium lactate is present in an amount of 1-8% by weight of the obtained gel.

17. The gel, according to claim 11, in which the gel contains fermented dextrose in an amount of 0.5-2.5% by weight of the gel.

18. A process for producing the gel as described in claim 11, comprising the steps of:
a) hydrating a blend of isolated plant-based protein, salts of alginate and a calcium source;
b) adding oil to turn the product obtained from step a) into an alginate emulsion;
c) hydrating a texturized plant-based protein;
d) mixing the hydrated protein from step c) with the alginate emulsion from step b); and
e) leaving the mixture of step d) for gelling at refrigeration temperature for at least 3 hours.

19. A plant-based food product containing the gel as described in claim 11 in amounts of 10-100% of the plant-based food product.

20. The plant-based food product according to claim 19, wherein the product is selected from a burger, a sausage, a nugget, dices for pizza toppings, dices for salads, bacon, a steak and a schnitzel.

21. A process for obtaining a finished uncooked plant-based food product of 19, wherein:
the process comprises adding and mixing a gelling composition with a plant-based food product; and
the gelling composition comprises:
a) a source of at least one plant protein, giving a total amount of protein of from about 1 to about 75 weight % in the gelling composition based on the total weight of the gelling composition;
b) salts of alginate in a total amount of about 10 to 75 weight % in the gelling composition based on the total weight of the gelling composition; and
c) an encapsulated calcium source present from half (w/w) the amount of the alginate to four times the amount of the alginate in the gelling composition.

22. A process for obtaining an isolated soy or pea protein food product, wherein:
the process comprises:
placing the gelling compositions in different layers, and
carrying out gelation of the gelling compositions; and
the gels:
comprise from 5 to 35% of a gelling composition as described in claim 1,
have at least 500 g of gel strength breaking point,
are minced and not pastes, and
do not contain methyl cellulose.
